(19) United States
(12) Patent Application Publication
(10) Pub. No.: US 2012/0167343 A1
(43) Pub. Date: Jul. 5, 2012

(54) Elastic Structure for Hinge

(76) Inventors: Yi Tai Wu, Suzhou (CN); Hsin Hung Lin, Suzhou (CN); Shu Hua Lin, Suzhou (CN); Shu Jiuan Lin, Suzhou (CN)

(21) Appl. No.: 13/007,720

(22) Filed: Jan. 17, 2011

(30) Foreign Application Priority Data
Dec. 30, 2010 (CN) 201010614489.3

(51) Int. Cl. E05F 1/12

(52) U.S. Cl. 16/277

(57) ABSTRACT

A hinge includes a base, an arm, and an elastic element. The base includes a recessed body having a rear wall with a supporting portion. The arm includes a pivotal portion and two cam portions. A first pin section of a fixing pin member is extended through the pivotal portion and connected to the base. The elastic element includes two front elastic portions, a rear elastic portion, two intermediate portions each interconnected to one of the front elastic portions, and two extensions each interconnected between the rear elastic portion and one of the intermediate portions. The front elastic portions press against the cam portions. The intermediate portions are connected to the base by a second pin section of the fixing pin member. The rear elastic portion abuts the supporting portion of the rear wall.

### BACKGROUND OF THE INVENTION

1. Field of the Invention

The present invention relates to elastic structure for a hinge and, more particularly, to elastic structure for a furniture hinge.

2. Description of the Related Art

U.S. Pat. No. 5,617,612 to Ferrarai et al. discloses a single-pin furniture hinge including a cup-shaped element and an arm-shaped element pivoted together to reciprocally rotate from an open position to a closed position. A pressure spring includes free ends each resting on two sides of the arm-shaped element. The pressure spring further includes a central loop reacting against a bottom of the cup-shaped element. A fastening pin is extended through coils of the pressure spring, allowing relative movement between the cup-shaped element and the arm-shaped element. The free ends of the pressure spring remain pressing against the arm-shaped element such that elastic force of the pressure spring can be transmitted to the central loop of the pressure spring. However, the central loop of the pressure spring directly pressing against the bottom of the cup-shaped element is liable to deteriorate due to rigid contact between the deformed central loop and the bottom of the cup-shaped element, shortening the service life of the pressure spring.

Thus, a need exists for a novel furniture hinge avoiding the above disadvantages.

### SUMMARY OF THE INVENTION

An objective of the present invention is to provide elastic structure for a hinge to provide an arm of the hinge with enhanced elasticity and flexibility, prolonging the service life of an elastic element of the hinge.

According to an aspect of the present invention, a hinge includes a base having a recessed body. The body includes a bottom wall, two sidewalls, a front wall located at front ends of the sidewalls, and a rear wall located at rear ends of the sidewalls. The sidewalls and the front and rear walls extend upward from the bottom wall and together define a receiving space. An arm includes an end having a pivotal portion and two cam portions adjoining the pivotal portion. An elastic element includes two front elastic portions, a rear elastic portion, two intermediate portions each interconnected to one of the front elastic portions, and two extensions each interconnected between the rear elastic portion and one of the intermediate portions. The front elastic portions press against the cam portions. A fixing pin member includes a first pin section and a second pin section parallel to the first pin section. The first pin section is connected to a first location of the base and extended through the pivotal portion of the arm, allowing relative pivotal movement between the base and the arm. The second pin section is connected to a second location of the base and extended through the intermediate portion of the elastic element. The elastic element is retained in the receiving space of the base by the second pin. The rear wall of the base includes a supporting portion to support the rear elastic portion of the elastic element. The rear elastic portion and the extensions disengage from the bottom wall of the base when the base moves relatively to the arm.

Preferably, the supporting portion is a protrusion, and the rear elastic portion of the elastic element abuts the protrusion.

Preferably, the supporting portion is a hole, and the rear elastic portion of the elastic element includes at least one protruded section extending into the hole and abutting an inner periphery of the hole.

Preferably, with the elastic element is a double-twist type spring. Preferably, the fixing pin member is a U-shaped member including a third pin section interconnecting the first and second pin sections.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows an exploded, perspective view of a hinge of a first embodiment according to the present invention.

FIG. 2 shows a perspective view of the hinge of FIG. 1.

FIG. 3 shows a cross sectional view of the hinge of FIG. 1.

FIG. 4 shows a perspective view of a hinge of a second embodiment according to the present invention.

FIG. 5 shows a cross sectional view of the hinge of FIG. 4.

FIG. 6 shows a perspective view of a hinge of a third embodiment according to the present invention.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

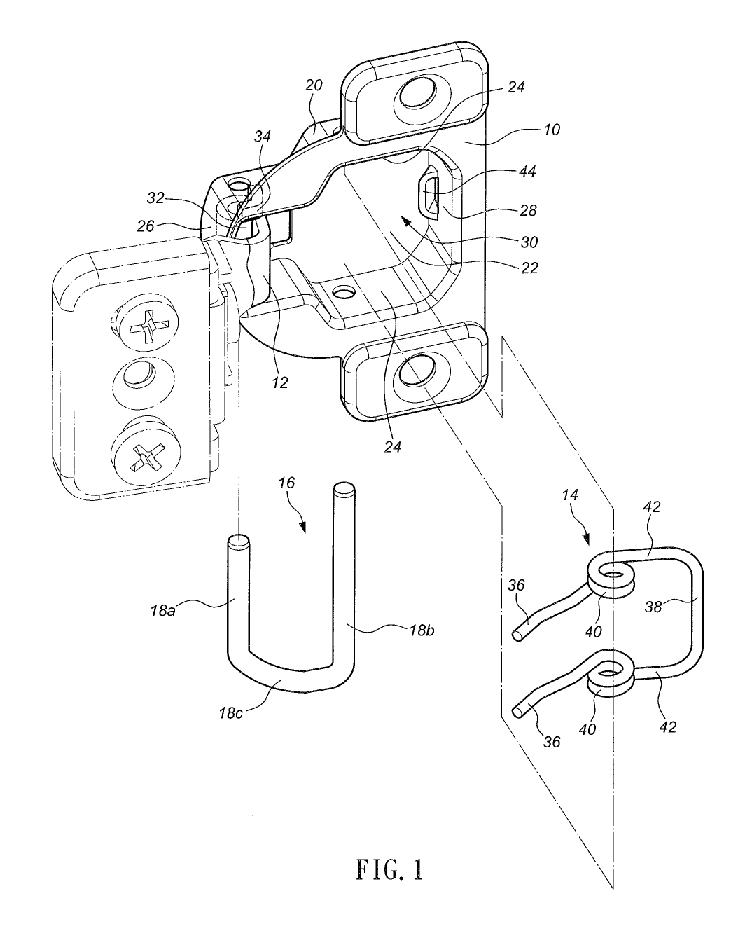

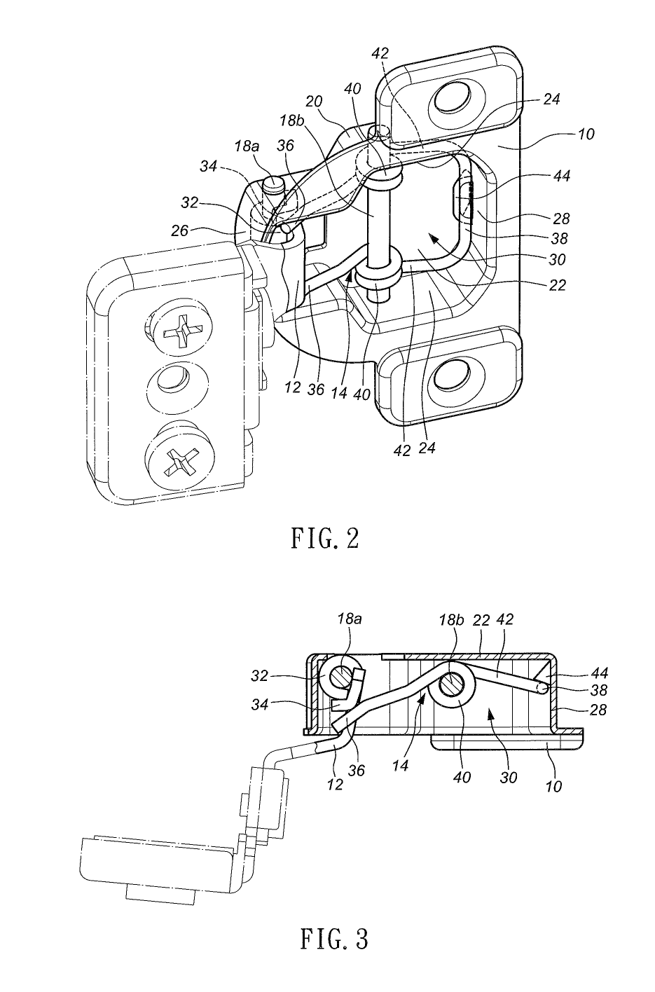

FIGS. 1-3 show a hinge of a first embodiment according to the present invention. The hinge includes a base 10, an arm 12, an elastic element 14, and a fixing pin member 16.

The base 10 includes a recessed body 20. The recessed body 20 includes a bottom wall 22, two sidewalls 24, a front wall 26 located at front ends of the sidewalls 24, and a rear wall 28 located at rear ends of the sidewalls 24. The sidewalls 24 and the front and rear walls 26 and 28 extend upward from the bottom wall 22 and together define a receiving space 30.

The arm 12 includes an end having a pivotal portion 32 and two cam portions 34 adjoining the pivotal portion 32. In a preferred form, the pivotal portion 32 is formed by coiling to provide a coiled portion having a hole.

The elastic element 14 is a double-twist type spring. The elastic element 14 includes two front elastic portions 36, a rear elastic portion 38, two intermediate portions 40 each interconnected to one of the front elastic portions 36, and two extensions 42 each interconnected between the rear elastic portion 38 and one of the intermediate portions 40. The two front elastic portions 36 press against the two cam portions 34 of the arm 12, respectively. Each intermediate portion 40 includes coils formed by winding. The rear elastic portion 38 abuts the rear wall 28 of the base 10. Preferably, the rear wall 28 of the base 10 includes a supporting portion 44 to support the rear elastic portion 38 such that the rear elastic portion 38 and the extensions 42 can disengage from the bottom wall 22 of the base 10. In a preferred form, the supporting portion 44 is a protrusion, and the rear elastic portion 38 abuts the protrusion.

The fixing pin member 16 is substantially a U-shaped member including a first pin section 18a, a second pin section 18b parallel to the first pin section 18a, and a third pin section 18c interconnected between the first and second pin sections 18a and 18b. The first pin section 18a is connected to first locations of the sidewalls 24 of the base 10 and extended through the pivotal portion 32 of the arm 12, allowing the base 10 to pivot about the arm 12 at the center of the first pin section 18a. The second pin section 18b is connected to second locations of the sidewalls 24 of the base 10 and extended through the intermediate portions 40 of the elastic element 14. Thus, the elastic element 14 is retained in the receiving space 30 of the base 10 by providing the second pin section 18b.

By such an arrangement, the elastic element 14 generates elastic force pressing against the arm 12, enabling the base 10 to move relatively to the arm 12. When the base 10 moves relatively to the arm 12, the front elastic portions 36 of the elastic element 14 remain pressing against the cam portions 34 of the arm 12. Furthermore, the rear elastic portion 38 abuts the rear wall 28 (particularly at the supporting portion 44 of the rear wall 28) of the base 10 for supporting purposes. Thus, the front elastic portions 36 of the elastic element 14 keeps acting on the arm 12 while the base 10 moves relatively to the arm 12 such that the rear elastic portion 38 of the elastic element 14 withstands pressing force from the front elastic portions 36. Thus, the rear elastic portion 38 and the extensions 42 can disengage from the bottom wall 22 of the base 10 instead of continuously pressing against the bottom wall 22 of the base 10. As a result, a gap exists between the rear elastic portion 38 of the elastic element 14 and the bottom wall 22 of the base 10, providing a room for flexible, extending movement for the rear elastic portion 38 of the elastic element 14 while the rear elastic portion 38 of the elastic element 14 is subjected to force.

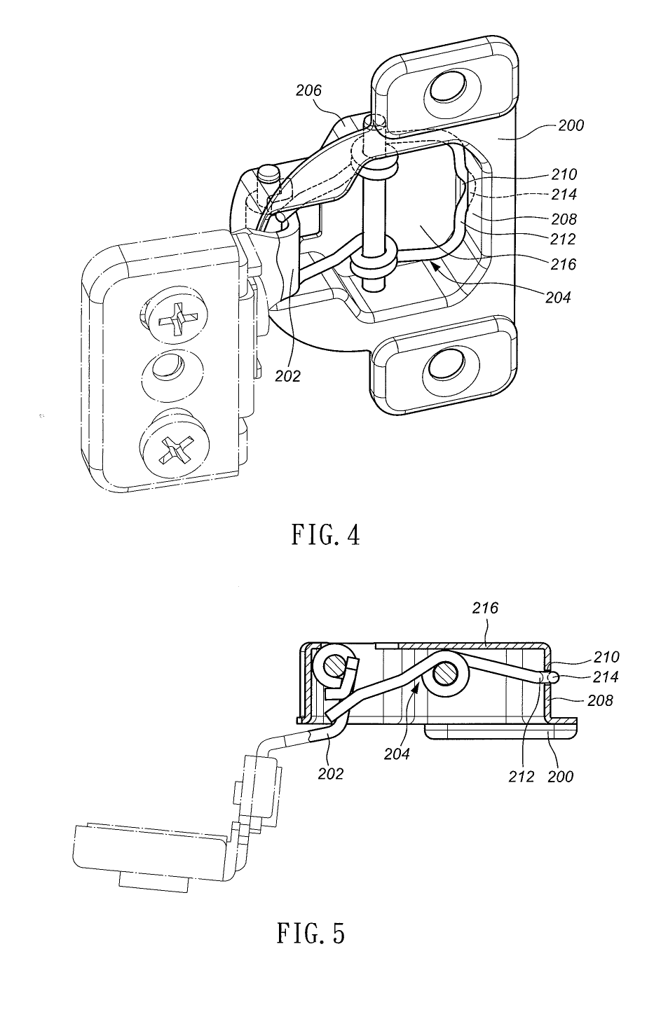

FIGS. 4 and 5 show a hinge of a second embodiment according to the present invention, wherein the hinge includes a base 200, an arm 202, and an elastic element 204. In this embodiment, the base 200 includes a recessed body 206 having a rear wall 208. The rear wall 208 has a supporting portion 210, and a rear elastic portion 212 of the elastic element 204 abuts the supporting portion 210. In this embodiment, the supporting portion 210 is in the form of a hole, and the rear elastic portion 212 of the elastic element 204 includes at least one protruded section 214 extending into the hole and abuts an inner periphery of the hole. By such an arrangement, the rear elastic portion 212 of the elastic element 204 does not directly press against the bottom wall 216 of the base 200, providing a suitable gap between the rear elastic portion 212 of the elastic element 204 and the bottom wall 216 of the base 200 and providing a room for flexible, extending movement for the rear elastic portion 212 of the elastic element 204 while the rear elastic portion 212 of the elastic element 204 is subjected to force.

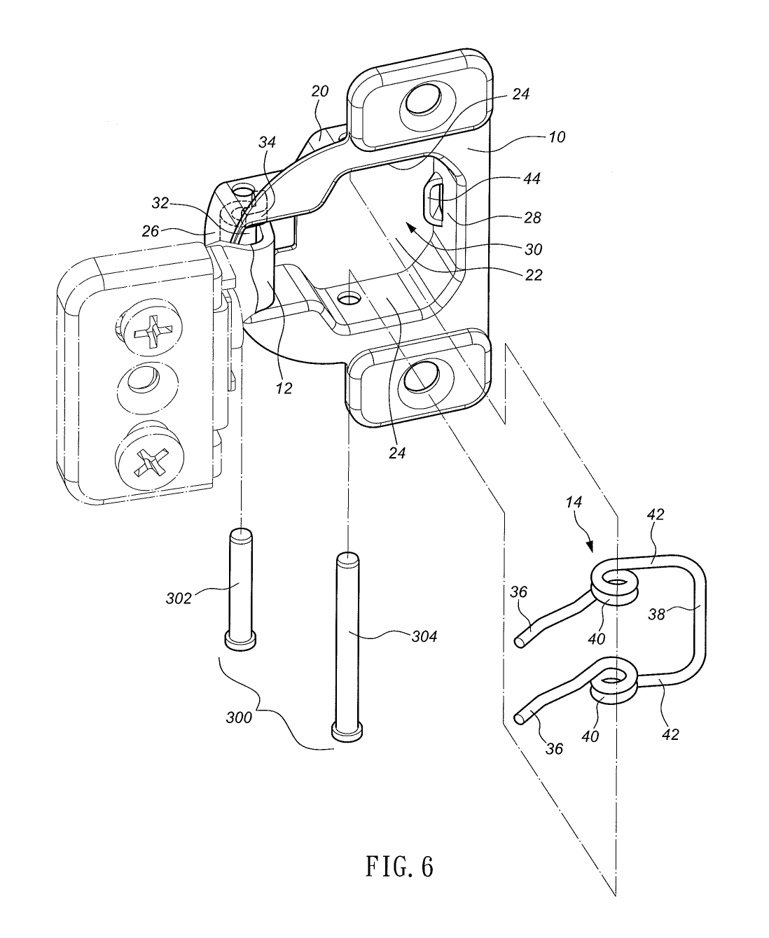

FIG. 6 shows a hinge of a third embodiment according to the present invention, wherein the fixing pin member 300 includes two separate pin sections 302 and 304 for respectively connecting the first and second locations of the body 10.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A hinge comprising:
a base including a recessed body, with the recessed body including a bottom wall, two sidewalls, a front wall located at front ends of the two sidewalls, and a rear wall located at rear ends of the two sidewalls, with the two sidewalls and the front and rear walls extending upward from the bottom wall and together defining a receiving space;
an arm including an end having a pivotal portion and two cam portions adjoining the pivotal portion;
an elastic element including two front elastic portions, a rear elastic portion, two intermediate portions each interconnected to one of the two front elastic portions, and two extensions each interconnected between the rear elastic portion and one of the two intermediate portions, with the two front elastic portions pressing against the two cam portions; and
a fixing pin member including a first pin section and a second pin section parallel to the first pin section, with the first pin section connected to a first location of the base and extended through the pivotal portion of the arm, allowing relative pivotal movement between the base and the arm, with the second pin section connected to a second location of the base and extended through the intermediate portion of the elastic element, with elastic element retained in the receiving space of the base by the second pin section,
wherein the rear wall of the base includes a supporting portion to support the rear elastic portion of the elastic element, the rear elastic portion and the two extensions disengage from the bottom wall of the base.

2. The hinge as claimed in claim 1, wherein the supporting portion is a protrusion, with the rear elastic portion of the elastic element abutting the protrusion.

3. The hinge as claimed in claim 1, wherein the supporting portion is a hole, with the rear elastic portion of the elastic element including at least one protruded section extending into the hole and abutting an inner periphery of the hole.

4. The hinge as claimed in claim 1, wherein the elastic element is a double-twist type spring.

5. The hinge as claimed in claim 1, wherein the fixing pin member is a U-shaped member, with the U-shaped member including a third pin section interconnecting the first and second pin sections.
